(19) United States
(12) Patent Application Publication
(10) Pub. No.: US 2017/0315088 A1
(43) Pub. Date: Nov. 2, 2017

(54) Validation of Peaks of and/or use of an Internal Lane Standard (ILS) Signal in DNA Genotyping

(71) Applicant: Analogic Corporation, Peabody, MA (US)

(72) Inventor: Ching-Ming LAI, Wakefield, MA (US)

(73) Assignee: Analogic Corporation, Peabody, MA (US)

(21) Appl. No.: 15/520,726

(22) PCT Filed: Oct. 23, 2014
(86) PCT No.: PCT/US2014/061867

§ 371 Date: Apr. 20, 2017

(51) Int. Cl. G01N 27/447; G06F 19/18; G01N 15/14; B01L 3/00; G06F 19/26

(52) U.S. Cl. CPC G01N 27/44726; G06F 19/26; G06F 19/18; G01N 27/44782; G01N 15/14; B01L 3/502761; G01N 27/44791; B01L 2400/0421; B01L 2300/0654; G01N 2015/1493

(57) ABSTRACT

A sample processing apparatus (102) includes a plurality of processing stations (108) configured to process a sample that includes a DNA sample and an ILS substance carried by a sample carrier. One of the plurality of processing stations includes an electrophoresis processing station. The sample processing apparatus further includes an optical reader (110) that generates a plurality of DNA sample color group signals and an ILS signal based on a result of the electrophoresis processing station. One of the DNA sample color group signals includes at least the locus amelogenin X-peak. The sample processing apparatus further includes an ILS signal validator (112) that validates peaks of the ILS signal as true peaks of the ILS signal only if the amelogenin X-peak of the one of the DNA sample color group signals is found between two peaks of the ILS signal.

### TECHNICAL FIELD

The following generally relates to DNA analysis and finds particular application to the validation and/or use of an internal lane standard signal (ILS) in DNA genotyping.

### BACKGROUND

DNA genotyping includes a process of determining a sequence of DNA nucleotides at a generic locus, i.e., at a position on a chromosome of a gene or other chromosome marker. For the purpose of identifying a person, certain generic loci have been selected as the standard markers to characterize the person's DNA. Each marker is a DNA fragment containing a repetition of a certain nucleotide sequence. There are 13 core and several other markers that have been used, for example, by the security authorities. These markers contain short repetitions (roughly from 5 to 40) of the four nucleotides. They are in the class of Short Tandem Repeat (STR) of DNA sequence.

The repetition numbers at these markers varies randomly amongst people. The specific form of DNA sequence at a generic locus is called an allele. To measure an allele number, a DNA fragment containing all STR nucleotides and adjacent sections of nucleotides at each locus is copied from the DNA sample and replicated through polymerase chain reaction (PCR). The fragment size is measured in the unit of base pair, where a base pair is the size of a pair of DNA nucleotides. A substance containing synthesized fragments of only known fragment sizes is added to the sample fluid. The synthesized fragments are referred to as the internal sizing standards or internal lane standard (ILS) fragments.

Because the sizes of ILS fragments are known, the acquisition times of the peaks in the ILS signal can be used to translate the acquisition times of the DNA fragments into their fragment sizes. Then, based on the DNA fragment sizes, the allele numbers of the fragments can be determined. However, the ILS signal may include false peaks and/or be missing peaks, e.g., due to color cross-talk, a primer not attaching to DNA fragments, data acquisition time limit, etc. In such instances, unfortunately, the DNA fragment size may not fit any known allele and/or an incorrect allele number may be determined for a fragment.

### SUMMARY

Aspects of the application address the above matters, and others.

In one aspect, a sample processing apparatus includes a plurality of processing stations configured to process a sample that includes a DNA sample and an ILS substance carried by a sample carrier. One of the plurality of processing stations includes an electrophoresis processing station. The sample processing apparatus further includes an optical reader (110) that generates a plurality of DNA sample color group signals and an ILS signal based on a result of the electrophoresis processing station. One of the DNA sample color group signals includes at least the locus amelogenin X-peak. The sample processing apparatus further includes an ILS signal validator (112) that validates peaks of the ILS signal as true peaks of the ILS signal only if the amelogenin X-peak of the one of the DNA sample color group signals is found between two peaks of the ILS signal.

In another aspect, a method for verifying two peaks of an ILS signal for DNA genotyping is discussed. The method includes receiving a DNA sample signal and receiving an ILS signal. The method further includes identifying the locus amelogenin single peak or double peaks in a DNA color group signal of the DNA sample signal. The method further includes comparing the locus amelogenin single peak or double peaks with a predetermined set of peaks of the ILS signal. The method further includes generating and outputting an acceptance signal in response to the set of peaks of the ILS signal being within a predetermined tolerance of the single peak or double peaks based on a result of the comparison.

In another aspect, an apparatus includes memory with computer executable instructions and a processor. The processor, in response to executing the computer executable instructions: receives a DNA sample color group signal that includes the locus amelogenin single peak or double peaks, receives a measured ILS signal, and verifies two peaks of the ILS signal for DNA genotyping based on the locus amelogenin single peak or double peaks.

Those skilled in the art will recognize still other aspects of the present application upon reading and understanding the attached description.

### BRIEF DESCRIPTION OF THE DRAWINGS

The application is illustrated by way of example and not limitation in the figures of the accompanying drawings, in which like references indicate similar elements and in which:

FIG. 1 schematically illustrates an example sample processing apparatus which includes an ILS signal validator;

FIG. 2 illustrates a sub-portion of an example DNA sample color group signal that includes the locus amelogenin X-peak;

FIG. 3 illustrates a sub-portion of an example DNA sample color group signal that includes the locus amelogenin X-peak and Y-peak;

FIG. 4 illustrates a sub-portion of an example ILS signal that includes peaks at least at 100 base pair and 120 base pair;

FIG. 5 illustrates a sub-portion of an example of a simulated ideal ILS signal that includes peaks at least at 100 base pair and 120 base pair;

FIG. 6 illustrates an example of the ILS signal validator;

FIG. 7 illustrates a peak at 104 base pair and a peak at 108 base pair of a color group signal and the peaks at 100 base pair and 120 base pair of the ILS signal;

FIG. 8 illustrates a variation of the ILS signal validator of FIG. 6;

FIG. 9 illustrates another example of the ILS signal validator;

FIG. 10 illustrates another variation of the sample processing apparatus of FIG. 1, which includes a DNA sample signal validator;

FIG. 11 illustrates an example of the DNA sample signal validator;

FIG. 12 illustrates an example of increasing peak width size of the ILS or DNA sample signal as a function of fragment size;

FIG. 13 illustrates an example method;

FIG. 14 illustrates another example method; and

FIG. 15 illustrates another example method.

### DETAILED DESCRIPTION

The following describes an approach for using a DNA gender fragment peak(s) (i.e., the X-peak or the X and Y peaks of the locus amelogenin) from a measured color group signal of a processed DNA sample to validate peaks (e.g., at least one, such as two) of a measured ILS signal of an ILS substance processed with the DNA sample. Furthermore, widths and/or shapes of peaks of the validated ILS signal can be used to predict a width and/or a shape of a DNA fragment peak and validate the DNA fragment peak as a true peak.

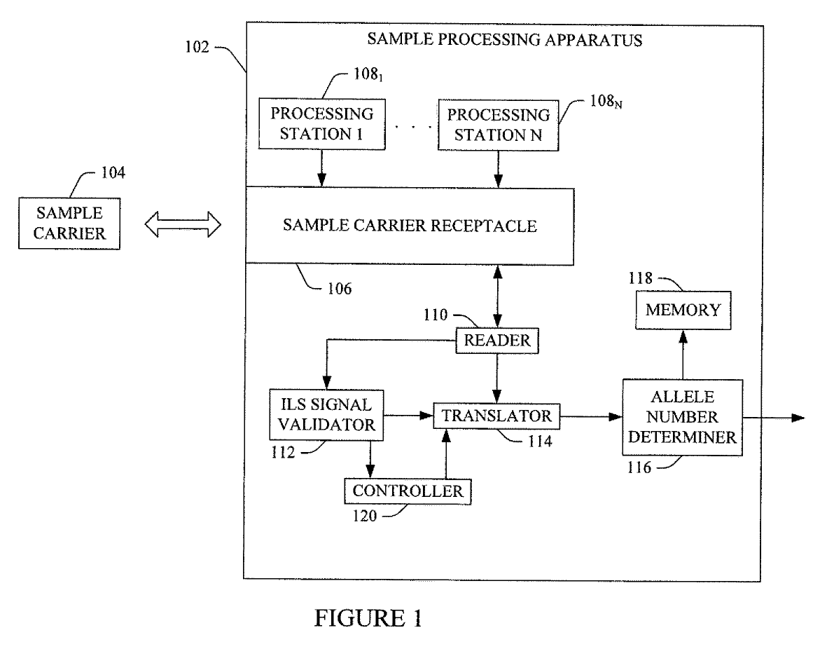

Initially referring to FIG. 1, a sample processing apparatus 102 is illustrated. The sample processing apparatus 102 is configured to process one or more samples carried by a sample carrier 104. The sample processing apparatus 102 includes a sample carrier receptacle 106 configured to receive the sample carrier 104 for processing the sample carried by the sample carrier 104 with the sample processing apparatus 102.

A suitable sample carrier 104 includes, but is not limited to, a biochip, a lab-on-a-chip, and/or other sample carrier. Such a sample carrier 104 may include one or more micro-channels (capillaries, lanes, etc.) for carrying and moving, in parallel and/or in series, one or more samples through a plurality of different processing regions of the sample carrier 104. In one instance, the sample carrier 104 includes a material such as glass, plastic or the like, with micro-channels with diameters on an order of one hundred microns or less.

A suitable sample includes, but is not limited to, a bio-sample (e.g., saliva, blood, skin cells, and/or other bio-material), a non-bio sample, etc. With respect to DNA genotyping, the sample is a DNA sample, and the carrier 104 carries the DNA sample and an ILS substance in a same channel. The sizes of the ILS fragments in the ILS substance are known and, as described below, are used to determine the sizes of the DNA fragments in the DNA sample. For example, the acquisition times of the peaks in the ILS signal are used to translate the acquisition times of DNA fragments into their fragment sizes. Based on the DNA fragment size, the allele numbers of the fragments are determined.

The sample processing apparatus 102 further includes one or more processing stations 108₁, . . . , 108_{N} (where N is a positive integer), collectively referred to herein as processing stations 108. The processing stations 108 are configured to process samples carried by a sample carrier(s) installed in the sample carrier receptacle 106. The processing stations 108 processes samples in different channels of the sample carrier 104 in parallel or in series. For DNA genotyping, the processing stations 108 are configured to extract and purify fragments, replicate and label fragments, and separate the labeled fragments based on fragment size, e.g., via electrophoresis at an electrophoresis processing station and/or otherwise.

For fragment labelling, the fragment sizes of the DNA sample of a locus are separated from other loci, and each group is referred to as a color group. For each color group, a fluorescent dye (or fluorophore) with a distinct fluorescent color is attached to the fragments of all loci in the group. The dyes can be attached to a molecule called primer at one end of the fragment. The fluorescent dyes label the fragments. Each fluorescent dye has a known emission spectrum, which is different from the emission spectra of the other dyes attached to the fragments of other groups.

For fragment separation, a negative electrode is at the entrance of the channel, and a positive electrode is at the other end of the channel. When an electrical potential is applied across the electrodes, an electric field is created and exerts a net electrostatic force on the surface charge of the fragments. The DNA and ILS fragments move or migrate toward the positive electrode at a speed that depends on the electric field strength, the fragment size, and/or other factors. Fragments of the same size arrive at the positive electrode end at the same time within a variance, separated from other fragments of different sizes.

The sample processing apparatus 102 also includes an optical reader 110. The reader 110 includes a light source that directs a light beam of a predetermined wavelength range at the separated DNA and ILS fragments. The light beam excites the dyes. Following the excitation, fluorescent light is emitted from the dyes, e.g., on the order of a microsecond, and lasts for a period on the order of a microsecond. The reader 110 also includes a detector that detects light emitted by the dyes of the DNA fragments and the ILS fragments in response to the dyes receiving the light and generates an analog and/or digital signal indicative of the detected light.

In one instance, the light source emits a relatively narrow light beam with a diameter in the order of ten (10) to one hundred (100) microns. In another instance, the light source emits a light beam with a smaller or large diameter. Examples of suitable light sources include, but are not limited to, a laser, a light emitting diode (LED), and the like. The reader 110 also includes an optical detection channel (e.g., a photo-multiplier tube (PMT), a charge-coupled device (CCD) camera, or the like) for each wavelength range (or color) of interest that generates an electrical signal in proportion to the intensity of the fluorescence light within the wavelength range. Each filtered fluorescent color is measured in a detection channel.

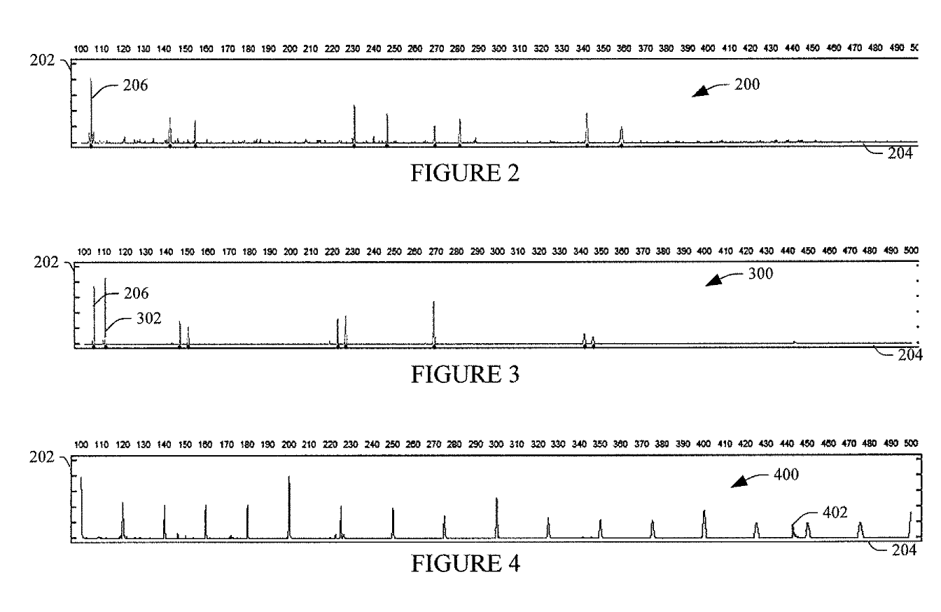

FIGS. 2 and 3 illustrate DNA sample signals 200 and 300 for a same color group for two different subjects. A y-axis 202 represents signal amplitude, and an x-axis 204 represents fragment size, e.g., for a sub-range from 100 base pair (bp) to 500 base pair. The DNA sample signal 200 corresponds to a female subject, and the DNA sample signal 300 corresponds to a male subject. As such, the DNA sample signal 200 will have an X-peak 206 for the locus amelogenin at approximately 104 base pairs, and the DNA sample signal 300 will have the X-peak 206 for the locus amelogenin at approximately 104 base pairs and a Y-peak 302 for the locus amelogenin at approximately 108 base pairs.

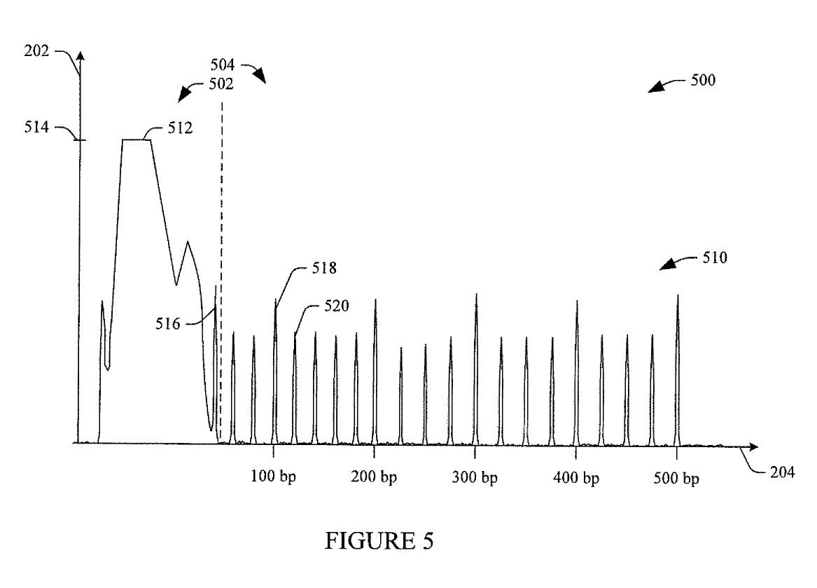

FIG. 4 illustrates an example signal 400 for a measured ILS substance for the same base pair range as that in FIGS. 2 and 3. The peaks are balanced with the exception of a spurious peak 402, which could be misinterpreted as a true peak of the signal 400. FIG. 5 shows a portion of a simulated ideal signal 500 for an ILS substance. The signal 500 includes a first region 502, which corresponds to a free-primer zone region, and a second region 504 with a plurality of ILS fragment peaks 510. For explanatory purposes, amplitudes of the peaks 510 are balanced, there are no unexpected peaks in the region 504 from a spurious fragment, the peaks of one color do not bleed into another color, nor do the peaks of one color affect the amplitude of a peak of another color.

The portion of the signal 500 in the free-primer zone region 502 is irregular and unpredictable. Furthermore, the amplitude of the portion of the signal 500 in the free-primer zone region 502 is greater than the amplitude of the portion of the signal 500 in the region 504 and, as shown at 512, may exceed and clip to a maximum value 514. The portion of the signal 500 in the free-primer zone region 502, in this example, also includes a spurious peak 516, which can be mistaken as a first peak of the ILS fragment peaks 210. The portion of the signal in the second region 504 has at least a peak 518 at about 100 base pairs and another peak 520 at about 120 base pairs.

Although FIGS. 2-5 show the X-peak and the Y-peak respectively at approximately fragment sizes of 104 and 108 base pairs and between the third and fourth peaks of the ILS signal, it is to be understood that the amelogenin location depends on the primer in the system. However, for explanatory purposes and sake of brevity the following is described for the case (FIGS. 2-5) where the X-peak and the Y-peak are at fragment sizes of 104 and 108 base pairs and between the third and fourth peaks of the ILS signal. In general, the approached described herein is well suited for cases where the locations of the X-peak and the Y-peak, with respect to one or more peaks of the ILS signal, are known.

Returning to FIG. 1, the sample processing apparatus 102 further includes an ILS signal validator 112. As described in greater detail below, the ILS signal validator 112 uses a DNA amelogenin fragment peak(s) (e.g., peak 206 or peaks 206 and 302 of FIG. 3) to accept (validate) or reject peaks of the ILS signal as true peaks of the ILS signal. The sample processing apparatus 102 further includes a translator 114. Other criterion can then be used to validate other peaks and the ILS signal. The translator 114 translates the DNA fragment peaks from units of migration (or acquisition) time to fragment size based on a validated ILS signal, producing ILS-translated DNA fragment sizes.

The sample processing apparatus 102 further includes an allele number determiner 116 that determines DNA allele numbers for each peak in the DNA signal based on the ILS translated DNA fragment size. In one instance, this may include using a mapping that maps ILS translated fragment size to allele number. This can be done by using the mapping to determine an allele number based on an ILS translated DNA fragment size. The allele numbers can be stored in local memory 118 and/or remote memory, printed to paper, electronically conveyed to another device, etc.

A controller 120 at least controls the ILS signal validator 112 and the translator 114. For example, where the ILS signal validator 112 identifies an ILS signal as a valid ILS signal, the controller 120 invokes the translator 114 to translate the DNA fragment signal. However, where the ILS signal validator 112 invalidates or rejects the ILS signal as a valid ILS signal, the controller 120 does not invoke the translator 114 to translate the DNA fragment signal. Instead, the controller 120 terminates processing. The controller 120 may also generate and display a message, via a display of the apparatus 102, for the operator, who can manually terminate processing.

It is to be appreciated that the ILS signal validator 112, the translator 114, the allele number determiner 116, the controller 120, and/or other component of the apparatus 102 can be implemented via one or more processors (e.g., a microprocessor, a central processing unit, etc.) implementing one or more computer readable instructions encoded on computer readable storage medium (which excludes transitory medium) such as physical memory. Additionally or alternatively, at least one of the one or more computer readable instructions can be carried by a carrier wave or signal. Furthermore, the ILS signal validator 112, the translator 114, the allele number determiner 116 and/or the controller 120 can be part of a computing system separate from the sample processing apparatus.

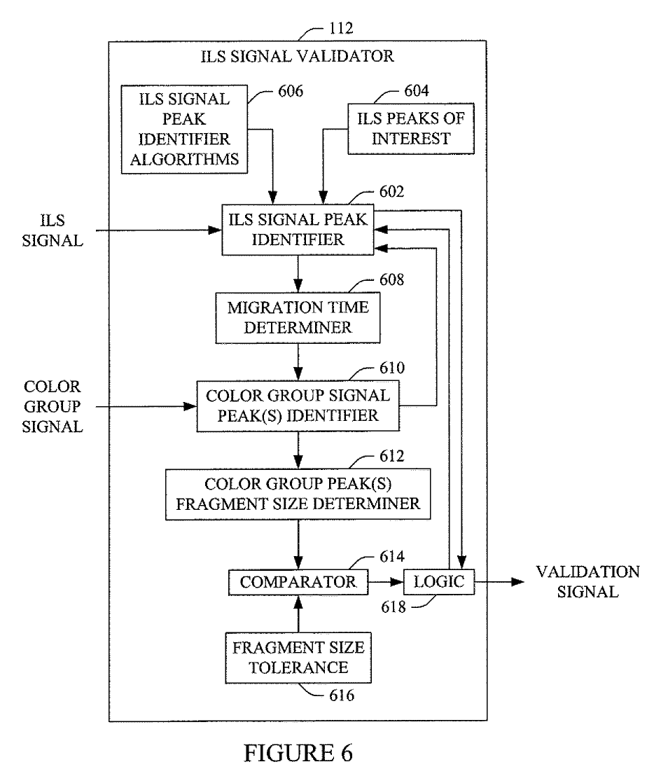

FIG. 6 illustrates an example of the ILS signal validator 112.

The ILS signal validator 112 includes an ILS signal peak identifier 602, a set of ILS peaks of interest 604, and a set of ILS signal peak identifier algorithms 606. The ILS signal peak identifier 602 receives, as an input, the ILS signal from the reader 110. The ILS signal peak identifier 602 identifies, employing an algorithm of the set of ILS signal peak identifier algorithms 606, a set of peaks in the received ILS signal as candidate peaks corresponding to peaks in the set of ILS peaks of interest 604. In one instance, the algorithm identifies a start peak identifier and a maximum number of peaks to process.

For example, the set of ILS peaks of interest 604 may indicate the 100 base pair and the 120 base pair peaks of the ILS signal (e.g., the peaks 518 and 520 of the signal 500 in FIG. 5) as the peaks of interest. Without any false or spurries peaks in the ILS signal 400, the 100 base pair peak is the third peak after the primer zone 502 and the 200 base pair peak is the fourth peak after the primer zone 502. In this example, the algorithm 606 indicates the ILS signal peak identifier 602 should initially identify the third peak and the fourth peak of the received ILS signal 400 as the candidate peaks for the ILS peaks of interest 604.

For a subsequent selection, e.g., where it turns out that the candidate peaks are not the ILS peaks of interest 604, the algorithm 606 may indicate a next pair of ILS peaks of the ILS signal 400 to process, e.g., the fourth and fifth peaks. This pattern is repeated for N−1 pairs of N peaks. Another algorithm of the set of ILS signal peak identifier algorithms 606 may indicate a different initial selection and/or a different subsequent selection(s). For example, instead of selecting neighboring adjacent pairs of peaks, the algorithm may indicate selecting the first pair of odd numbered peaks as the initial peaks, etc. If no candidate peaks are identified, the ILS signal peak identifier 602 outputs a genotyping stopping signal.

The ILS signal validator 112 further includes a migration time determiner 608. The migration time determiner 608 determines migration times (e.g., t₁ and t₂) for the peaks (e.g., peaks 518 and 510) identified by the ILS signal peak identifier 602 from the input ILS signal. The ILS signal validator 112 further includes a color group signal peak(s) identifier 610. The color group signal peak(s) identifier 610 identifies one or more peaks of the input color group signal with a migration time that falls within a range between the migration times determined by the migration time determiner 608. That is, the color group signal peak(s) identifier 610 identifies one or more peaks with migration times tₓ, . . . , t_{y} where t₁<tₓ<t_{y}<t₂.

The ILS signal validator 112 further includes a color group signal peak(s) fragment size determiner 612 that determines a fragment size of each of the one or more peaks identified by the color group signal peak(s) identifier 610. In one instance, the color group signal peak(s) fragment size determiner 612 determines a fragment size by employing a linear interpolation algorithm. As example of a suitable linear interpolation algorithm for determining a fragment size (FragSizeI) for a peak with a migration time of tₓ (and/or t_{y}) is shown in Equation 1;

$$FragSize 1 = RefBP 1 + ( RefBP 2 - RefBP 1 ) \frac{( {t}_{x} - {t}_{1} )}{( {t}_{2} - {t}_{1} )} ; \qquad Equation 1 ;$$

where RefBP1 represents the fragment size of the first reference peak (e.g., 100 in the example) and RefBP2 represents the fragment size of the second reference peak (e.g., 120 in the example).

The ILS signal validator 112 further includes a comparator 614 and a predetermined fragment size tolerance (T) 616 (e.g., ±1 base pair, ±0.5 base pair, ±0.25 base pair, etc.). Where only one peak is identified by the color group signal peak(s) identifier 610, the comparator 614 compares the fragment size FragSize1 with RefBP1±T. Where two peaks are identified by the color group signal peak(s) identifier 610, the comparator 614 compares a fragment size of the first peak FragSize1 with RefBP1±T and a fragment size of the second peak FragSize2 with RefBP2±T.

The comparator 614 generates and outputs an output signal indicative of a result of the comparison. For example, where only a single peak is identified by the color group peak(s) identifier 610, the output signal is “high”, “1”, etc. in response to (RefBP1−T)<FragSize1<(RefBP1+T), and “low”, “0”, etc. otherwise. In another example, where two peaks are identified by the color group peak(s) identifier 610, the output signal is “high”, “1”, etc. in response to both (RefBP1−T)<FragSize1<(RefBP1+T) and (RefBP2−T)<FragSize2<(RefBP2+T), and “low”, “0”, etc. otherwise.

The ILS signal validator 112 further includes logic 618. The logic 618 receives the genotype stopping signal produced by the ILS signal peak identifier 602 (if one is produced) or the output signal of the comparator 614. Where the logic 618 receives the genotype stopping signal produced by the ILS signal peak identifier 602, the logic 618 transmits a signal, which indicates the ILS signal has not been accepted or validated as a suitable ILS signal (or has been rejected), to the controller 120. The controller 120, in response thereto, terminates the DNA nucleotide sequencing process.

Where the logic 618 receives the output signal of the comparator 614 and the output signal indicates the fragment size(s) of the identified color group peak(s) is not within the tolerance T about the fragment size(s) of interest, the logic 618 transmits a signal to the ILS signal peak identifier 602, which invokes the ILS signal peak identifier 602 to select a subsequent pair of peaks in the received input ILS signal. In this example, this indicates that the initially selected third peak and/or fourth peak are not the true 100 base pair third and fourth 120 base pair peaks of the ILS signal, e.g., false peaks exist in the ILS signal

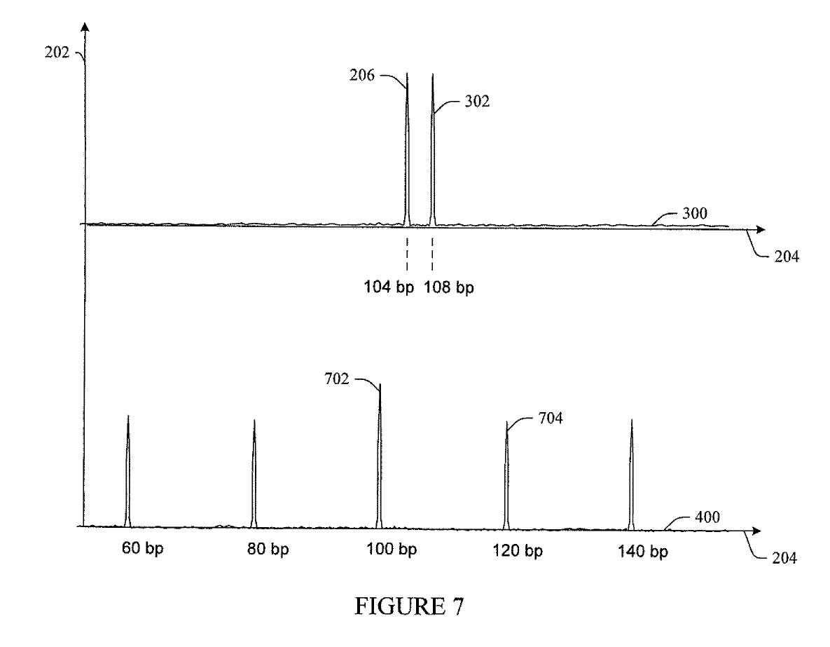

However, where this output signal indicates the fragment size(s) is within the tolerance T about the fragment size(s) of interest, the initially selected third peak and/or fourth peak are the true 100 base pair third and fourth 120 base pair peaks of the ILS signal, and the logic 618 transmits the ILS signal validation signal, which indicates or validates the two peaks are true peaks, to the controller 120. FIG. 7 shows an example in which third and fourth peaks 702 and 704 of the ILS signal 400 are the true 100 base pair and 120 base pair peaks as the X-peak 206 and the Y-peak 302 of the DNA color group signal 300 are between the third and fourth peaks 702 and 704 and satisfy the tolerance T conditions. The controller 120 and/or other component can validate other peaks of the ILS signal and/or the ILS signal.

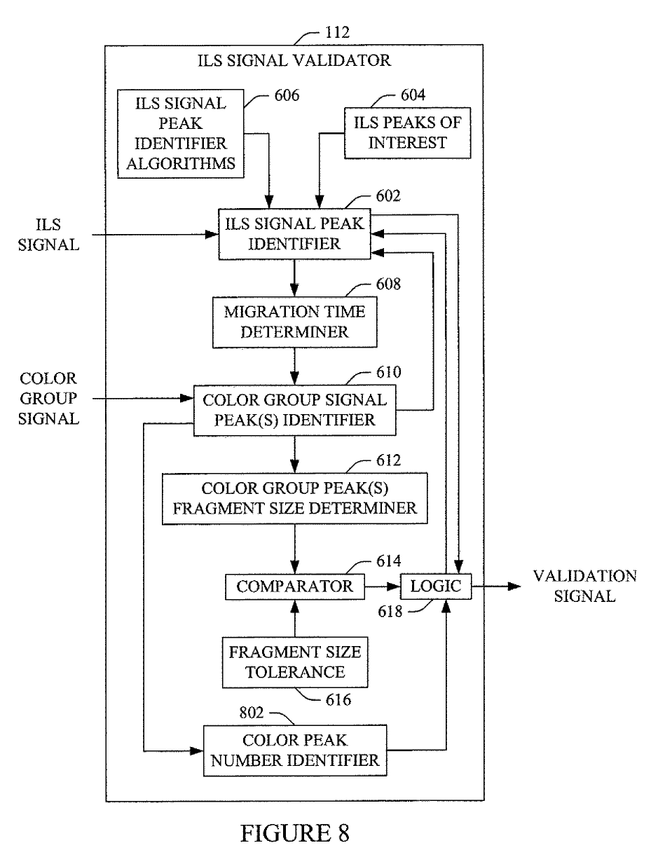

FIG. 8 illustrates a variation of FIG. 6. In this variation, the ILS signal validator 112 further includes a color peak number identifier 802. The color peak number identifier 802 identifies, by number, which of the peaks in the color group signal has been identified as the color group peak(s) by the color group peak(s) identifier 610. For example, where the identified peak is the first peak of the color group signal, the color peak number identifier 802 identifies the identified peak as the first peak. The logic 618 uses this information to further verify the ILS signal.

For example, in this variation, the logic 618, only where this output signal indicates the fragment size(s) is within the tolerance T about the fragment size(s) of interest (as describe above) and the color peak number identifier 802 identifies the color group peak at the expected number will the logic 618 transmit the ILS signal validation signal to the controller 120. This variation is well suited for sample processing apparatuses where the X-peak is the first peak of the color group signal, e.g., like the X-peak 206 of the signal 200 of FIG. 2.

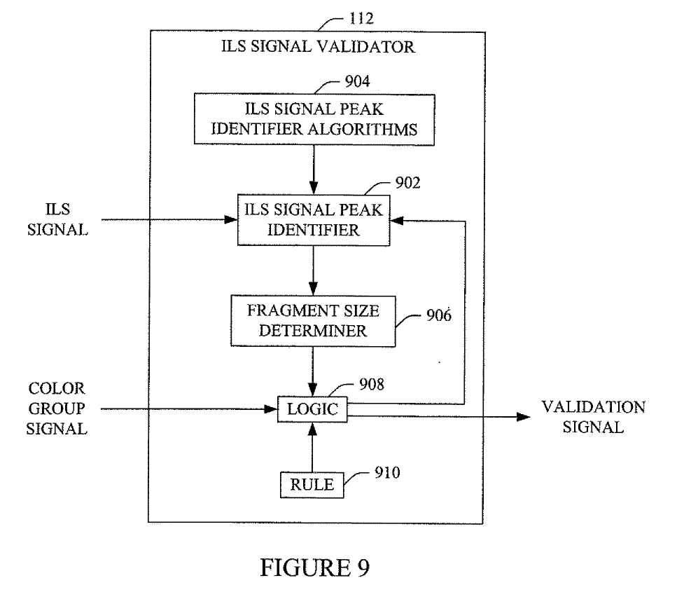

FIG. 9 illustrates another variation of the ILS signal validator 112.

The ILS signal validator 112 includes an ILS signal peak identifier 902 and a set of ILS signal peak identifier algorithms 904. The ILS signal peak identifier 902 receives, as an input, the ILS signal from the reader 110. The ILS signal peak identifier 902 identifies, employing an algorithm of the set of ILS signal peak identifier algorithms 904, a set of ILS peaks in the received ILS signal. The ILS signal validator 112 further includes an ILS fragment size determiner 906. In one instance, the ILS fragment size determiner 906 fits the set of ILS peaks into a curve of fragment size as function of migration time.

The ILS signal validator 112 further includes logic 908 and a predetermined rule 910. The logic 908 translates (or converts) the migration times of the peaks of the color group signal to fragment sizes based on the curve function determined by the ILS fragment size determiner 906. The logic 908 then searches the peaks of the color group signal for the X-peak and the Y-peak at the expected fragment size. In one instance, the rule 910 indicates that if the single peak at 104 base pair or the double peaks at 104 and 108 base pairs of the color group signal cannot be located based on the fragment sizes of a sub-set of peaks of the ILS signal or if more than two color group peaks are found within the fragment sizes of 100 base pairs and 112 base pairs, then the ILS peaks are not valid. In response thereto, the ILS signal peak identifier 902 selects a different set of peaks based on another algorithm, the logic 908 likewise evaluates the new set as valid peaks.

If after evaluating multiple sets of ILS peaks a valid set of ILS peaks cannot be found, the logic 908 transmits a signal, which indicates the ILS signal has not been accepted or validated as a suitable ILS signal (or has been rejected), to the controller 120. The controller 120, in response thereto, terminates the DNA nucleotide sequencing. However, if after evaluating one or more sets of ILS peaks a valid set of ILS peaks is found, the logic 908 transmits a signal, which indicates the peaks of the ILS signal have been accepted or validated as true peaks. to the controller 120, which can validate other peaks of the ILS signal and the ILS signal, and the DNA nucleotide sequencing process continues.

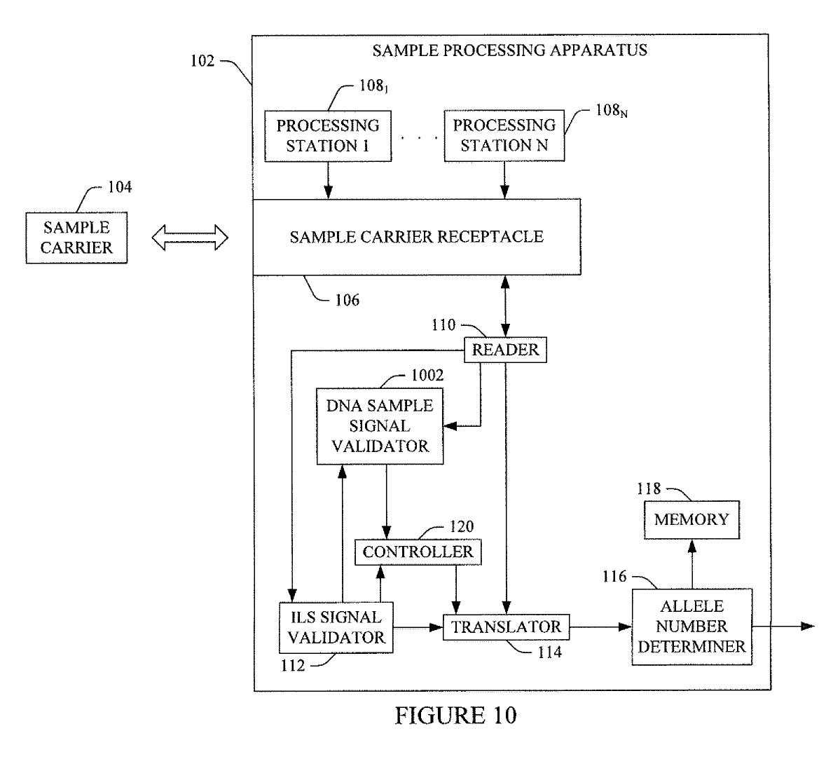

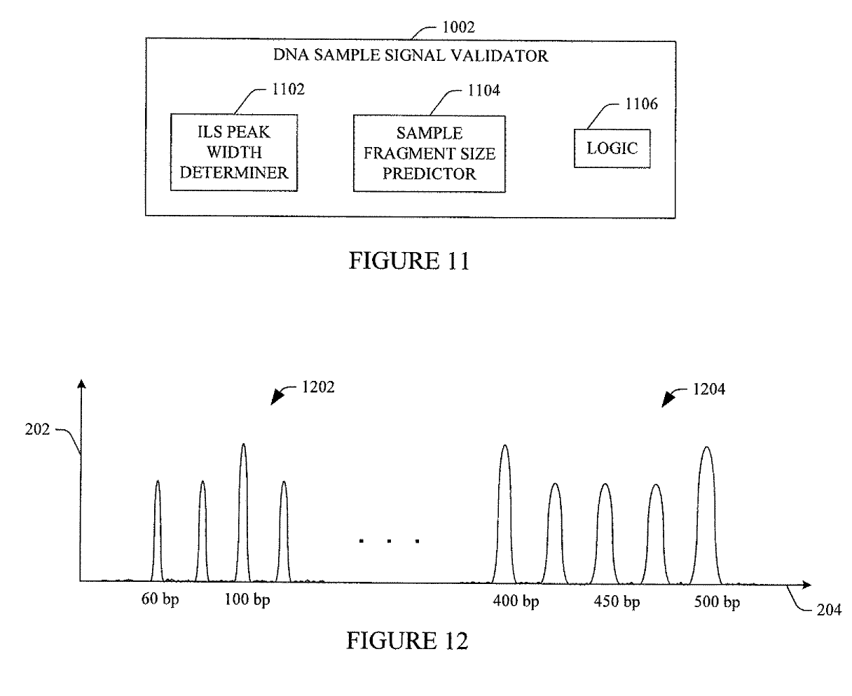

FIG. 10 illustrates a variation of FIG. 1. In this variation, the sample processing apparatus 102 further includes a DNA sample peak validator 1002. As show in FIG. 11, the DNA sample peak validator 1002 includes an ILS peak width determiner 1102, a sample fragment size predictor 1104, and logic 1106.

The ILS peak width determiner 1102 measures widths of the ILS signal peaks. The sample fragment size predictor 1104 fits the measured widths into a mathematical function against the peak fragment size and uses the function to predict or estimate the peak width of a DNA fragment size. An example of a suitable fitting function is shown in Equation 2:

ƒ(x)=a₀+a₁x+a₂x²+a₃x³+a₄x⁴, Equation 2:

which is a polynomial function of a fourth order. Other order polynomial functions are also contemplated herein. In Equation 2, x is the fragment size, ƒ (x) is the peak width, and a₀, a₁, a₂, a₃, and a₄, are coefficients determined from a best fit of ILS peaks. The expected peak width of a DNA fragment peak with fragment size x can be obtained from the function ƒ (x).

The logic 1106 determines whether to accept or reject the DNA fragment size based on the predicted widths. For example, the expected peak width can be used to measure a deviation of the DNA peak width, e.g., by taking the difference the predicted width and a measured width of the DNA peak. If the deviation exceeds certain percentage, the logic 1106 identifies the peak as a false peak and discards it. Otherwise, the logic 1106 validates the peak as a true peak.

In another instance, the logic 1106 estimates a shape of the DNA peak to be a Gaussian shape, and compares the shape of the estimated DNA fragment peak with a shape of the measured DNA fragment peak. If the deviation in shape exceeds certain percentage, the logic 1106 identifies the peak as a false peak and discards it. Generally, migration times of fragments of a same allele spread out such that the detected peak bears the shape of a Gaussian function with certain widths. FIG. 12 shows an example. In this example, peak width is narrower at smaller fragment sizes 1202 and larger at larger fragment sizes 1204. The width of an ILS peak varies with the fragment size in the same way as a width of a DNA fragment peak varies with its fragment size. The peak width is in the order of 0.5 base-pairs. The value of ƒ (x) provides the peak width for the Gaussian shape.

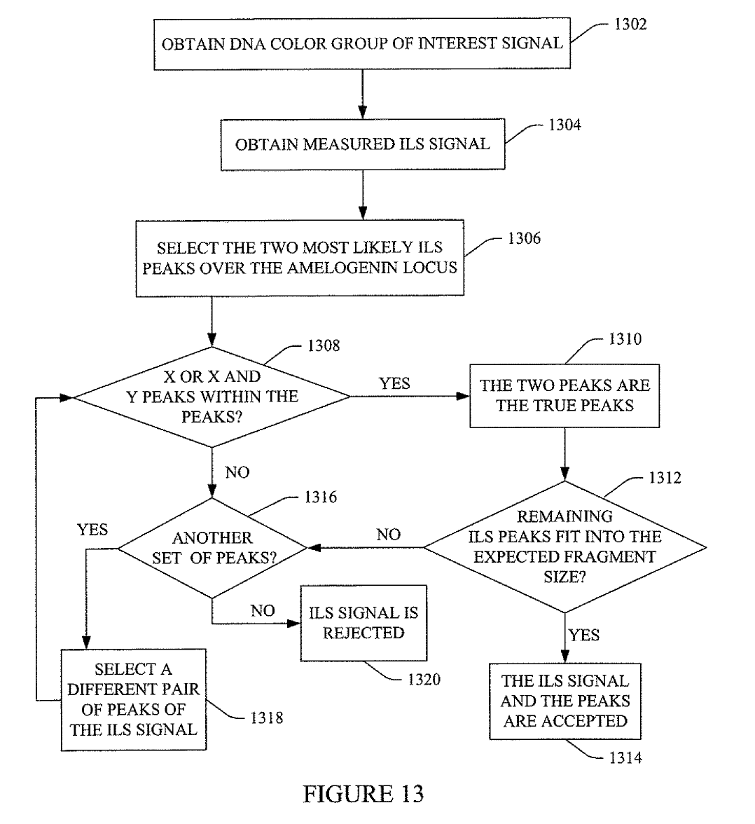

FIG. 13 illustrates a method. In this specific example, the amelogenin is located between the third and fourth peaks of the ILS signal.

It is to be appreciated that the ordering of the following acts is not-limiting. As such, in other embodiments, the ordering may be different, and one or more acts may occur concurrently. In addition, one or more acts may be added and/or one or more of the acts may be omitted.

At 1302, a measured DNA color group signal, which includes the DNA amelogenin single (X-peak) or double (X-peak and Y-peak) gender fragment peaks, is received from the reader 110.

At 1304, a measured ILS signal is received from the reader 110.

At 1306, two peaks of the measured ILS signal are selected as candidate peaks for the third and fourth true peaks of the ILS signal.

At 1308, it is determined if the X-peak or the X and Y-peaks of the DNA color group signal are within a range of fragment sizes of the two peaks of the ILS signal, as described herein.

At 1310, if so, the two peaks are identified as the true peaks.

At 1312, it is determined if the remaining ILS peaks fit into the expected fragment sizes.

At 1314, if so, then the ILS signal and the peak set are accepted.

In this instance, the ILS signal can be used to translate the DNA signal to fragment size and determine allele numbers based thereon. Optionally, other procedures may be used to continue the verifying the ILS signal, as described herein and/or otherwise.

If not or if at 1308 it is determined if the X-peak or the X and Y-peaks of the DNA color group signal are not within the range of fragment sizes of the two peaks of the ILS signal, then at 1316 it is determined if another set of peaks of the ILS signal are to be evaluated.

At 1318, if other peaks of the ILS signal are to be evaluated, then a different pair of peaks of the measured ILS signal is selected as the candidate third and fourth peaks, and act 1308 is repeated. The new pair of peaks can be the fourth and fifth peaks, the third and fifth peaks, and/or other different pair of peaks.

At 1320, if no other peaks of the ILS signal are to be evaluated, then the ILS signal is rejected.

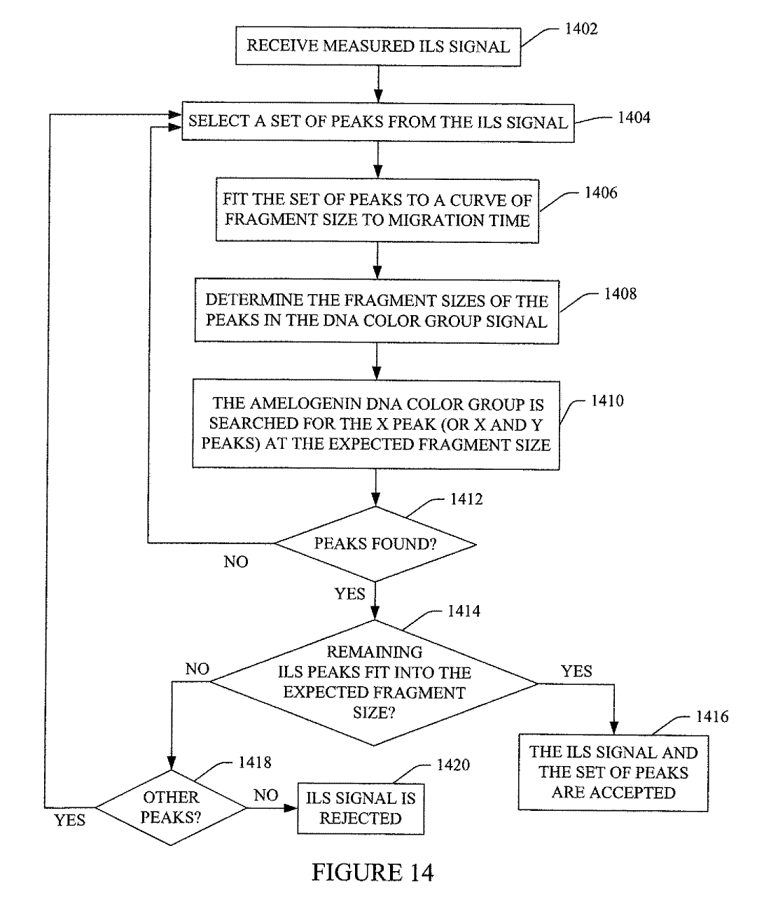

FIG. 14 illustrates another method.

It is to be appreciated that the ordering of the following acts is not-limiting. As such, in other embodiments, the ordering may be different, and one or more acts may occur concurrently. In addition, one or more acts may be added and/or one or more of the acts may be omitted.

At 1402, a measured ILS signal is received from the reader 110.

At 1404, a set of ILS peaks is selected.

At 1406, the selected ILS peaks are fitted to a curve of fragment size as function of migration time.

At 1408, the fragment sizes of the peaks in the DNA color group signal are determined from the curve.

At 1410, the amelogenin DNA color group is searched for the X-peak (or X and Y peaks) at the expected fragment size.

At 1412, if the X-peak (or X and Y peak) fragment size is not found, act 1404 is repeated with a different set of peaks.

At 1414, if the X-peak (or X and Y peak) fragment size is found, it is determined if the remaining ILS peaks fit the expected fragment sizes.

At 1416, if so, the ILS signal and the set of peaks are accepted.

At 1418, if not, then it is determined if there are other peaks to be evaluated.

If so, then act 1404 is repeated.

At 1420, if no other peaks of ILS signal are to be evaluated, then the ILS signal is rejected.

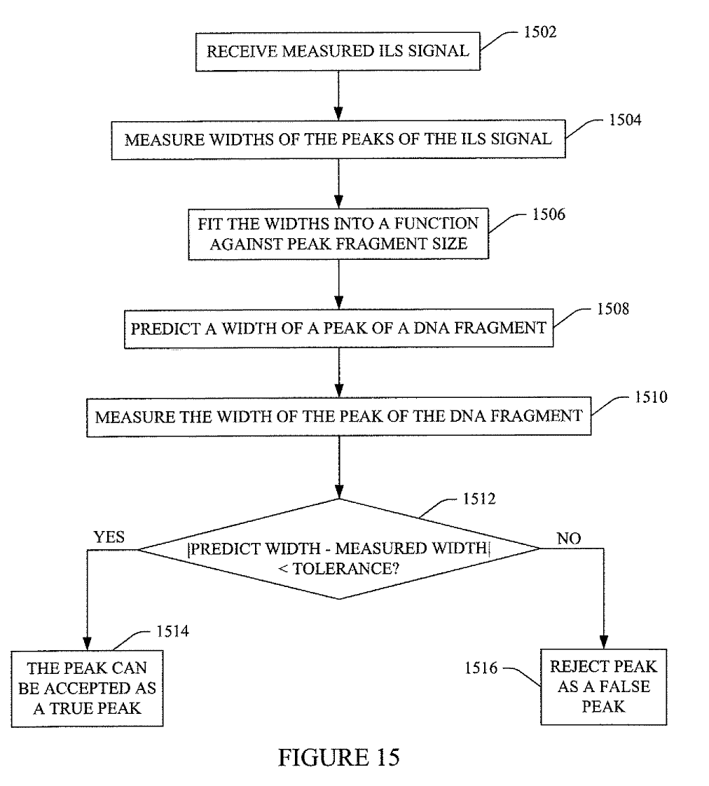

FIG. 15 illustrates another method.

It is to be appreciated that the ordering of the following acts is not-limiting. As such, in other embodiments, the ordering may be different, and one or more acts may occur concurrently. In addition, one or more acts may be added and/or one or more of the acts may be omitted.

At 1502, a measured ILS signal is received from the reader 110.

At 1504, widths of the peaks of the ILS signal are measured.

At 1506, the measured widths are fit into a mathematical function against peak fragment sizes.

At 1508, the function is used to predict the peak width of a DNA fragment.

At 1510, a width of the peak of the DNA fragment is measured.

At 1512, it is determined if the predicted and measured widths are within a predetermined width tolerance.

At 1514, if the difference there between satisfies the predetermined width tolerance, the peak can be accepted as a true peak, if other criterions is met.

At 1516, if the difference there between does not satisfy the predetermined width tolerance, the peak is rejected as a false peak.

It is to be appreciated that the above can be implemented via one or more processor of one or more computing systems executing one or more computer readable and/or executable instructions stored on computer storage medium such as memory local to or remote from the one or more computing systems.

The application has been described with reference to various embodiments. Modifications and alterations will occur to others upon reading the application. It is intended that the invention be construed as including all such modifications and alterations, including insofar as they come within the scope of the appended claims and the equivalents thereof.

1. A sample processing apparatus, comprising:
a plurality of processing stations configured to process a sample that includes a DNA sample and an ILS substance carried by a sample carrier, wherein one of the plurality of processing stations includes an electrophoresis processing station;
an optical reader that generates a plurality of DNA sample color group signals and an ILS signal based on a result of the electrophoresis processing station, wherein one of the DNA sample color group signals includes at least a locus amelogenin X-peak; and
an ILS signal validator that validates peaks of the ILS signal as true peaks of the ILS signal only if the amelogenin X-peak of the one of the DNA sample color group signals is found between two peaks of the ILS signal.

2. The sample processing apparatus of claim 1, wherein the ILS signal finds the amelogenin X-peak of the one of the DNA sample color group signals between the two peaks of the ILS signal in response to locating a fragment size of the amelogenin X-peak of the one of the DNA sample color group signals between a first fragment size of one predetermined peak of the peaks of the ILS signal and a second fragment size of a different predetermined peak of the ILS signal of the peaks.

3. The sample processing apparatus of claim 1, wherein the one of the DNA sample color group signals further includes a locus amelogenin Y-peak, and the validator validates the peaks of the ILS signal as the true peaks of the ILS signal only if the amelogenin X-peak and the amelogenin Y-peak are found between two peaks of the ILS signal.

4. The sample processing apparatus of claim 3, wherein the ILS signal finds the amelogenin X-peak and the amelogenin Y-peak of the one of the DNA sample color group signals between the two peaks of the ILS signal in response to locating the fragment size of the amelogenin X-peak and a fragment size of the amelogenin Y-peak between the first fragment size of the one predetermined peak of the ILS signal and the second fragment size of the different predetermined peak of the ILS signal.

5. The sample processing apparatus of claim 2, wherein the ILS signal validator rejects the ILS signal as the true ILS signal if the fragment size of the amelogenin X-peak is outside the predetermined fragment size range of the amelogenin X-peak.

6. The sample processing apparatus of claim 1, further comprising:
validating other peaks of the ILS signal and the ILS signal as a true ILS signal;
a translator that translates peak migration time of peaks of the plurality of DNA sample color group signals to fragment size based on the peaks of ILS signal in response to the ILS being validated as the true ILS signal; and
an allele number determiner that determines an allele number for the sample based on the ILS translated fragment sizes.

7. The sample processing apparatus of claim 1, wherein the ILS signal validator identifies and selects the amelogenin X-peak with peaks of the ILS signal prior to validating the ILS signal.

8. The sample processing apparatus of claim 1, wherein the ILS signal validator identifies and selects the amelogenin X-peak as the expected peak of the one of the DNA sample color group signals.

9. The sample processing apparatus of claim 1, further comprising:
a DNA sample validator that measures widths of peaks of the ILS signal, estimates a width of a peak of one of the DNA sample color group signals using the widths as references, measures a width of the DNA peak, determines a difference width value between the estimated width and the measured width, and validates the DNA peak as a true peak only if the difference width value is within a predetermined width tolerance.

10. The sample processing apparatus of claim 9, wherein the DNA sample validator estimates a shape of the DNA peak to be a Gaussian shape with a certain width.

11. The sample processing apparatus of claim 9, wherein the DNA sample validator fits the widths of the peaks of the ILS signal into a function that maps a width of a peak with a size of a fragment.

12. The sample processing apparatus of claim 11, wherein the function is a polynomial function having a predetermined order.

13. A method for verifying two peaks of an ILS signal for DNA genotyping, comprising:
receiving a DNA sample signal;
receiving an ILS signal;
identifying the locus amelogenin single peak or double peaks in a DNA color group signal of the DNA sample signal;
comparing the locus amelogenin single peak or double peaks with a predetermined set of peaks of the ILS signal; and
generating and outputting an acceptance signal in response to the set of peaks of the ILS signal being within a predetermined tolerance of the single peak or double peaks based on a result of the comparison.

14. The method of claim 13, further comprising:
generating and outputting a rejection signal in response to none of peaks of the ILS signal being within the predetermined tolerance of the single peak or double peaks based on the result of the comparison.

15. The method of claim 14, further comprising:
determining widths of peaks of the ILS signal;
predicting a width of a peak of the DNA sample signal;
measuring a width of the peak of the DNA sample signal;
comparing the predicted width and the measured width of the peak of the DNA sample signal; and
verifying the measured width of the DNA sample signal based on the comparison.

16. The method of claim 15, further comprising:
estimating the width of the peak of the DNA sample signal to have a Gaussian shape at this width;
comparing the estimated shape at this width with a shape of the peak of the DNA sample signal; and
verifying the shape of the peak of the DNA sample signal based on the comparison.

17. The method of claim 15, further comprising:
fitting the widths of the peaks of the ILS signal into a function that maps a width of a peak with a size of a fragment.

18. The method of claim 17, wherein the function is a polynomial function having a predetermined order.

19. The method of claim 13, further comprising:
selecting the single peak or double peaks based on a set of peaks of the ILS signal or a set of peaks of the DNA sample signal if the amelogenin is known to be a first locus of the DNA color group.

20. An apparatus, comprising:
a memory with computer executable instructions; and
a processor, which, in response to executing the computer executable instructions:
receives a DNA sample color group signal that includes the locus amelogenin single peak or double peaks;
receives a measured ILS signal; and
verifies two peaks of the ILS signal for DNA genotyping based on the locus amelogenin single peak or double peaks.
